(19) United States
(12) Patent Application Publication
(10) Pub. No.: US 2007/0086401 A1
(43) Pub. Date: Apr. 19, 2007

(54) Wireless USB host, wireless USB device, method of providing function of dual role device host, and method of performing function of dual role device host

(75) Inventors: Jin-woo Hong, Suwon-si (KR); Dae-gyu Bae, Suwon-si (KR); Hyun-ah Sung, Seoul (KR); Se-hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/527,520

(22) Filed: Sep. 27, 2006

(30) Foreign Application Priority Data
Sep. 27, 2005 (KR) 10-2005-0090002

(51) Int. Cl. H04Q 7/24

(52) U.S. Cl. 370/338

(57) ABSTRACT

A wireless universal serial bust (USB) host, a wireless USB device, a method of providing the function of a dual role device host, and a method of performing the function of the dual role device. The wireless USB host includes a searching unit which searches whether a wireless USB device can create a beacon on the basis of a message received in a wireless USB point-to-point communication environment; a control transfer packet creating unit which creates a control transfer packet including beacon synchronization information, channel time allocation information, and information on a transmission direction of data on the basis of the searched result; and a transmitting/receiving unit which transmits the control transfer packet on the basis of the beacon synchronization information and performs data communication with the wireless USB device on the basis of the channel time allocation information and the information on the transmission direction of data.

### CROSS-REFERENCE TO RELATED APPLICATION

This application claims priority from Korean Patent Application No. 10-2005-0090002 filed on Sep. 27, 2005, in the Korean Intellectual Property Office, the disclosure of which is incorporated herein by reference in its entirety.

### BACKGROUND OF THE INVENTION

1. Field of the Invention

Apparatuses and methods consistent with the present invention relate to a wireless universal serial bus (USB), and more particularly, to a wireless USB host, a wireless USB device, a method of providing the function of a dual role device host, and a method of performing the function of a dual role device host.

2. Description of the Related Art

With the development of communication and network techniques in recent years, wired network environments using a wire medium, such as a coaxial cable or an optical cable, have changed into wireless network environments using radio waves in various frequency bands.

Such wireless networks are classified into two types: wireless networks including an access point 110 as shown in FIG. 1; and wireless networks not including an access point as shown in FIG. 2. The wireless network including the access point is referred to as an “infrastructure-mode wireless network”. In the infrastructure-mode wireless network, the access point 110 functions to relay data in order to connect a wireless network to a wired network or to perform communication among wireless network apparatuses belonging to a wireless network. Therefore, in the infrastructure-mode wireless network environment, all data is transmitted through the access point 110.

Meanwhile, the wireless network not including the access point is referred to as an “ad-hoc-mode wireless network”. In the ad-hoc-mode wireless network, data packets are directly transmitted among wireless network apparatuses belonging to a single wireless network, without passing through a relay apparatus, such as the access point.

Ad-hoc-mode wireless networks are divided into two types. In one type of ad-hoc-mode wireless network, one wireless network apparatus which is arbitrarily selected from wireless network apparatuses belonging to a single wireless network serves as an arbitrator for allocating data packet transmission time (hereinafter, referred to as ‘channel time’) to the other wireless network apparatuses, and the other wireless network apparatuses transmit the data packets in the channel time allocated thereto.

In the other type of ad-hoc-mode wireless network, a wireless network apparatus, serving as an arbitrator, is not provided, and all the wireless network apparatuses can transmit data packets by mutual agreement therebetween whenever they want to transmit the data packets.

Wireless interfaces for wirelessly connecting network apparatuses are needed to perform communication in a wireless network environment. These wireless interfaces include, for example, IrDA and Bluetooth. In recent years, research has been conducted on a wireless USB, which is an advanced version of USB, a conventional wire interface.

The following is a brief description of advantages of the USB. A serial port has a maximum speed of 100 Kbps, but the USB can support a data transmission speed of 12 Mbps. In addition, when the USB is used as an interface between network apparatuses, it is possible to reduce the number of adapters and thus to simplify the structure of the network apparatus. Further, the use of the USB makes it unnecessary to install additional software or hardware when peripheral apparatuses are connected to a PC. In addition, since all peripheral apparatuses are connected to the PC using the same connectors, it is possible to considerably reduce the number of ports. Also, the USB can be easily installed, and it is possible to reduce the size of a portable PC.

FIG. 3 is a diagram showing a dual role device that performs the functions of a host and a device in the conventional wireless USB environment. Also, FIG. 3 shows an apparatus in a point-to-point mode.

Wireless USBs are classified into three types according to the degree of recognition on a mechanism of a physical layer, that is, a self-beaconing device, a directed-beaconing device, and a non-beaconing device. The self-beaconing device completely recognizes a physical layer protocol and can perform all functions related to a beacon. The directed-beaconing device does not recognize a physical layer protocol and thus recognizes an adjacent apparatus with respect to the proper use of a beacon, depending on a host. In addition, since the non-beaconing device has low transmission power and receiving sensitivity, it does not affect or is not affected by adjacent apparatuses that are not detected by a host.

FIG. 3 shows a default link formed between a host and a device when one of two apparatuses provided in a network functions as the host and the other apparatus functions as the device. The host searches a device capable of providing the function of a point-to-point dual role device (DRD) in the network. When the device is searched out, the host sets a reverse link to the device. That is, the host sets a reverse link to the self-beaconing device. When the reverse link is set, the device performs the function of the host, and the host performs the function of the device.

In this case, a device performing the function of a host at first searches a device providing the function of a point-to-point dual role device host in the network, that is, the self-beaconing device. When the device searched out in the network does not provide a beacon, that is, when a non-beaconing device is searched out in the network, the device cannot provide the function of a point-to-point DRD host. When the reverse link is set, the device performing the function of a host should create a beacon and broadcast it.

Therefore, a method of making a device unable to provide a beacon function as a point-to-point DRD host is needed.

### SUMMARY OF THE INVENTION

The present invention is made in view of the above-mentioned problems, and it is an aspect of the invention to provide a technique for realizing a point-to-point network using only a default link without a reverse link in a wireless USB environment.

Further, in another aspect of the invention, there is provided a technique for making a device that is unable to provide a beacon function as a dual role device host.

The present invention is not limited to the above-mentioned aspects, and other aspects of the present invention not described herein will become clear to those skilled in the art upon review of the following description.

According to an aspect of the invention, a wireless USB host includes a searching unit which searches whether a wireless USB device can create a beacon on the basis of a message received in a wireless USB point-to-point dual role device communication environment; a control transfer packet creating unit which creates a control transfer packet including beacon synchronization information, channel time allocation information, and information on a transmission direction of data on the basis of the searched result; and a transmitting/receiving unit which transmits the control transfer packet on the basis of the beacon synchronization information and performs data communication with the wireless USB device on the basis of the channel time allocation information and the information on the transmission direction of data.

According to another aspect of the invention, a wireless USB device includes a packet analyzing unit which analyzes a control transfer packet received in a wireless USB point-to-point dual role device communication environment; a management packet creating unit which creates a management packet including channel time allocation information and information on a transmission direction of data on the basis of the analyzed result; and a transmitting/receiving unit which transmits the management packet and performs data communication with a wireless USB host on the basis of the channel time allocation information and the information on the transmission direction of data.

According to still another aspect of the invention, a method of providing the function of a dual role device host includes searching whether a wireless USB device can create a beacon on the basis of a message received in a wireless USB point-to-point dual role device communication environment; creating a control transfer packet including beacon synchronization information, channel time allocation information, and information on a transmission direction of data on the basis of the searched result; and transmitting the control transfer packet on the basis of the beacon synchronization information and performing data communication with the wireless USB device on the basis of the channel time allocation information and the information on the transmission direction of data.

According to yet another aspect of the invention, a method of performing the function of a dual role device host includes analyzing a control transfer packet received in a wireless USB point-to-point dual role device communication environment; creating a management packet including channel time allocation information and information on a transmission direction of data on the basis of the analyzed result; and transmitting the management packet and performing data communication with a wireless USB host on the basis of the channel time allocation information and the information on the transmission direction of data.

Details of aspects of the invention other than the above-mentioned aspects are includes in the detailed description of the invention and the drawings.

### BRIEF DESCRIPTION OF THE DRAWINGS

The above and other aspects of the present invention will become more apparent by describing in detail preferred embodiments thereof with reference to the attached drawings, in which:

FIG. 1 is a diagram illustrating a wireless network in an infrastructure mode;

FIG. 2 is a diagram illustrating a wireless network in an ad-hoc mode;

FIG. 3 is a diagram illustrating a dual role device (DRD) that performs the functions of a host and a device in a related art wireless USB environment;

FIG. 4 is a diagram illustrating a wireless USB system formed of a DRD according to an exemplary embodiment of the invention;

FIG. 5 is a diagram illustrating a control transfer packet according to an exemplary embodiment of the invention;

FIG. 6 is a diagram illustrating the arrangement of wireless USB channels according to an exemplary embodiment of the invention;

FIG. 7 is a diagram illustrating a payload of DRP information according to an exemplary embodiment of the invention;

FIG. 8 is a diagram illustrating a header of DRP information according to an exemplary embodiment of the invention;

FIG. 9 is a block diagram illustrating a wireless USB host according to an exemplary embodiment of the invention;

FIG. 10 is a block diagram illustrating a wireless USB device according to an exemplary embodiment of the invention;

FIG. 11 is a flow chart illustrating a process of providing the function of a dual role device host according to an exemplary embodiment of the invention; and

FIG. 12 is a flow chart illustrating a process of performing the function of a dual role device host according to an exemplary embodiment of the invention.

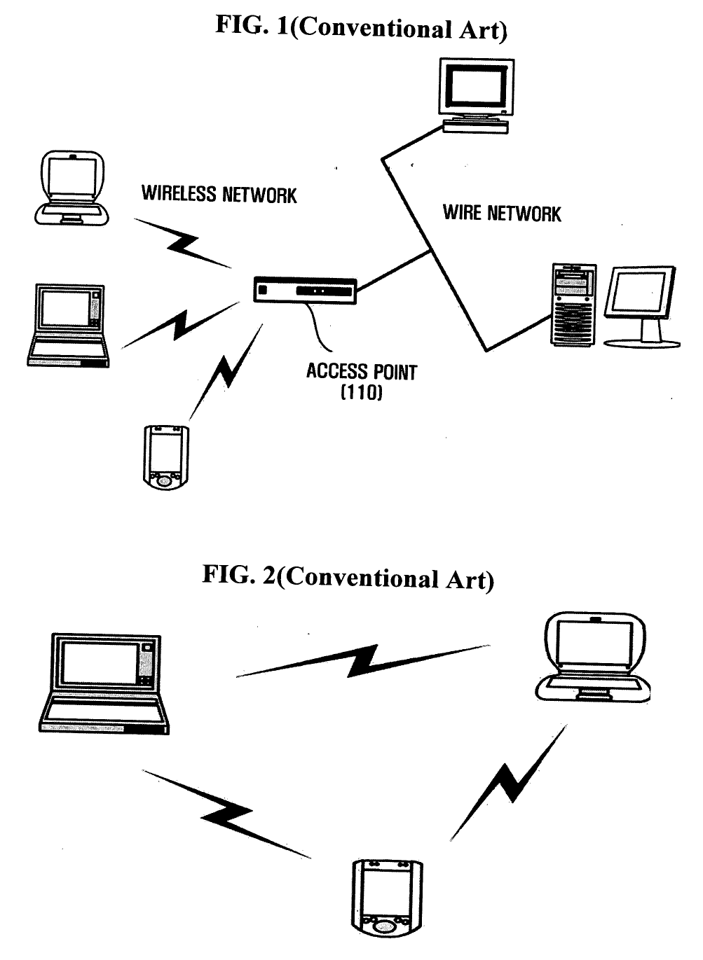

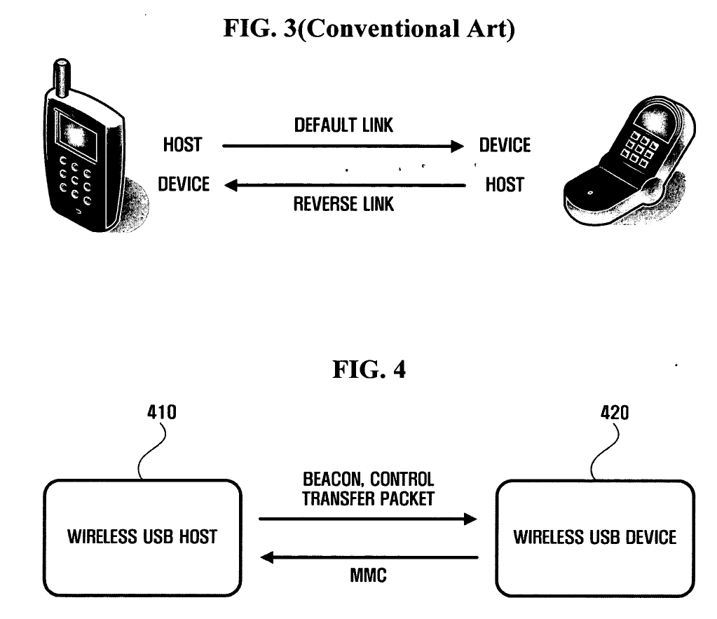

### DETAILED DESCRIPTION OF EXEMPLARY EMBODIMENTS

Aspects of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described below with reference to the accompanying drawings.

FIG. 4 is a diagram illustrating a wireless USB system composed of a dual role device (hereinafter, referred to as a DRD). As shown in FIG. 4, the wireless USB system includes a wireless USB host 410 and a wireless USB device 420.

In this structure, it is assumed that the wireless USB host 410 performs the function of a DRD host, and the wireless USB device 420 performs the function of the DRD.

First, the host 410 and the device 420 performing the functions of the DRDs in a wireless USB environment will be described below.

An apparatus having one transceiver can simultaneously perform the functions of the wireless USB host 410 and the wireless USB device 420 in the wireless USB environment. This is executed by various modes including a combination mode and a point-to-point mode.

In the combination mode, an apparatus performs the function of a device to connect an upstream to one or more individual wireless USB channels, and also performs the function of a host to manage the wireless USB channels. For example, a wireless USB printer that performs the function of a device to connect an upstream to one or more wireless USB channels can provide a wireless USB channel required for connection to a camera.

In the point-to-point mode, two wireless USB DRDs are connected to each other as the host 410 and the device 420, respectively.

In the combination mode, the wireless USB DRD host and the wireless USB DRD are logically separated from each other. Therefore, the wireless USB DRD host performs only the function of the wireless USB host 410, and the wireless USB DRD performs only the function of the wireless USB device 420.

In the point-to-point mode, two wireless USB DRDs connected to each other by one upstream wireless USB link and one downstream wireless USB link form a pair of point-to-point DRDs. The wireless USB link set first is referred to as a default link, and the wireless USB link set subsequently is referred to as a reverse link. The pair of point-to-point DRDs should exist in the same physical layer (Media Access Control (MAC) layer) channel. That is, pairing two point-to-point DRDs is performed through two stages, a default link setting stage and a reverse link setting stage.

The default link and the reverse link share the same connection context and session context. Therefore, a connection host identifier of the point-to-point DRD in the default link is the same as a connection device identifier of the point-to-point DRD in the reverse link. Only the DRD host of the default link can modify the contexts.

The two stages include a step of searching out the point-to-point DRD host in order to set up the default link and a step of pairing the point-to-point DRDs in order to set up the reverse link.

The step of searching out the point-to-point DRD host in order to set up the default link includes a user instructed discovery process for initial connection and a self-discovery process for reconnection.

The point-to-point DRD first supplied with power in the initial connection process serves as the DRD host. The point-to-point DRD subsequently supplied with power searches media to find the corresponding point-to-point DRD host. That is, the point-to-point DRD tries to access the point-to-point DRD host.

The host capable of performing the function of the point-to-point DRD sets a bit of “1” indicating that the function of the point-to-point DRD is available to a host information element of a micro-scheduled management command (hereinafter, referred to as an MMC). Then, the device capable of performing the function of the point-to-point DRD searches the periphery thereof to find out the position of the point-to-point DRD host.

When the point-to-point DRD completes the connection process, the point-to-point DRD obtains the connection context and the default link, and the host searches the device. Then, the point-to-point DRD returns a device capability descriptor having a point-to-point DRD capability field set to “1” and a beacon behavior field set to “11B”. A value related to the beacon behavior, such as the creation and transmission of a beacon, is input into the beacon behavior field by the point-to-point DRD. For example, values 00B, 01B, 10B, and 11B indicating reservation, self-beaconing, directed beaconing, and non-beaconing, respectively, can be input to the beacon behavior field.

When the point-to-point DRD is searched out by the point-to-point DRD host, the point-to-point DRD host starts setting up the reverse link.

In case of reconnection, a pair of point-to-point DRDs performs the previous function in the previous session, and the pair of point-to-point DRDs resets the default link through the reconnection process. At that time, when the pair of point-to-point DRDs does not reset the link within a predetermined time, the user may perform this operation.

In an authentication step of the connection process, after the default link is set up, the point-to-point DRD host allocates its beacon slot and wireless USB cluster to the same physical channel (MAC channel) in the revere link, and sets the point-to-point DRD availability bit of the host information element included in the MMC to “1”. Then, the point-to-point DRD host tries to perform reconnection.

After finding the wireless USB device 420, which is the point-to-point DRD, in the default link, the point-to-point DRD host performs the function of the device in the reverse link to start finding out the position of a host where the connection host identifier in the reverse link is the same as the connection device identifier in the default link.

In the reverse link, the point-to-point DRD uses the same connection context as that in the default link to perform reconnection. In this case, the authentication step in the connection process is omitted. Then, the point-to-point DRD uses a security USB control transfer packet SetAddress (0) to perform authentication therebetween.

In the searching step, the point-to-point DRD returns the device capability descriptor where the point-to-point DRD capability is set to zero in the reverse link.

In order to set up the subsequent default link, the point-to-point DRDs successful in making a pair store the connection context and the corresponding function in the default link.

In an exemplary embodiment of the invention, when the wireless USB device 420 does not support the beacon behavior and thus it does not perform the function of the point-to-point DRD host, the wireless USB device 420 returns, to the wireless USB host 410, the device capability descriptor having the point-to-point DRD capability field set to “1” and the beacon behavior field set to “11B”. Then, the wireless USB host 410 can recognize that the searched-out wireless USB device 420 cannot support the function of the point-to-point DRD host. As a result, the reverse link is not set between the wireless USB host 410 and the wireless USB device 420.

At that time, the wireless USB host 410 allows the wireless USB device 420 to use the control transfer packet to perform the function of the point-to-point DRD host. That is, in order to allow the wireless USB device 420 to use the control transfer packet to perform the function of the point-to-point DRD host, the wireless USB host 410 provides, for example, information on the transmission direction of data and channel time allocation information required to create the MMC. Then, the wireless USB host 410 and the wireless USB device 420 can communicate with each other through only the default link. The beacon and the control transfer packet are transmitted in a beacon synchronizing period, and the wireless USB device 420 transmits the MMC in a wireless USB cluster distributed reservation protocol (hereinafter, referred to as DRP) period.

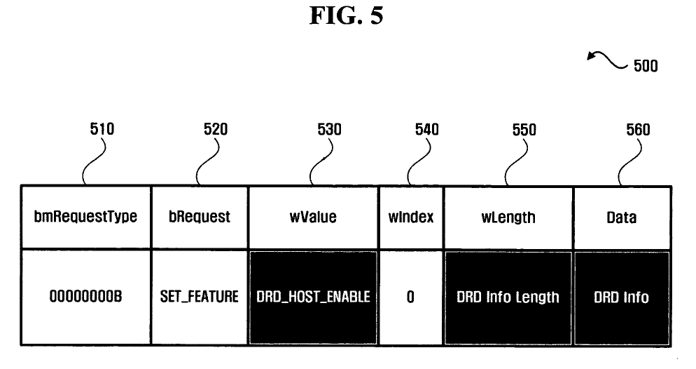

FIG. 5 is a diagram illustrating an example of the control transfer packet according to this exemplary embodiment of the invention.

A USB pipe means association between an endpoint of a device and software of a host, and the pipe indicates data transmission capability between the software of the host and the endpoint of the device through a memory buffer.

A pipe composed of two endpoints having an endpoint No. “0” is referred to as a default control pipe. The default control pipe is used by USB system software to identify an apparatus, to determine a setting request, and to set up the apparatus.

Pipe communication includes a stream having no USB definition structure and a message having the USB definition structure. The default control pipe corresponds to the message pipe.

All USB devices reply to the request of the wireless USB host through the default control pipe. In this case, the control transfer packet 500 is used for the host's request. The request and request parameters are transmitted to the device through a setup packet, and the host creates fields included in the setup packet.

The wireless USB host transmits standard device requests defined by all the USB devices. In this case, in order to enable the wireless USB device 420 to perform the function of the point-to-point DRD host, the wireless USB host 410 of the exemplary embodiment of the present invention sets “SET_FEATURE” into a bRequest field 520 of the standard device request and transmits a set feature control transfer packet 500.

The set feature control transfer packet 500 is a request message for activating a detailed feature and is used to transmit DRP information to the wireless USB device 420. A detailed description of the DRP information will be made later with reference to FIG. 7.

As shown in FIG. 5, the control transfer packet 500 includes a bmRequestType field 510, a bRequest field 520, a wValue field 530, a wIndex field 540, a wLength field 550 and a Data field 560.

The bmRequestType field 510 is used to identify the feature of the detailed request by the wireless USB host, and can also be used to identify the transmission direction of data in the next stage. When the wLength field 550 is set to zero, which means no data, the bmRequestType field 510 may be neglected.

The bRequest field 520 is used to specify a specific request, and the meaning of the bRequest field 520 can be modified according to the value of the bmRequestType field 510. In this exemplary embodiment, the bRequest field 520 is set to “SET_FEATURE”, which indicates that the transmission control message is a set feature control transmission message.

The value of the wValue field 530 depends on the type of request, and the wValue field 530 is used to transmit a predetermined parameter to the wireless USB device 420. In addition, the value of the wValue field 530 can be appropriately set according to the type of receiver. In this exemplary embodiment, the wValue field 530 is used only when the receiver is a device. In this exemplary embodiment, the value of the wValue field 530 can be set to “DRD_Host_Enable”, causing the wireless USB device 420 having received the message to know that it will perform the function of the point-to-point DRD host in response to the request of the wireless USB host 410.

The value of the wIndex field 540 depends on the type of request, similar to the value of the wValue field 530, and is used to transmit a predetermined parameter to the wireless USB device 420. In this exemplary embodiment, the value of the wIndex field 540 is set to zero.

The wLength field 550 is a field indicating the size of data to be transmitted in the next stage. When the value of the wLength field 550 is set to zero, no data transmission stage exists. In this exemplary embodiment, the wLength field 550 is used to indicate the size of DRP information.

The DRP information having a size equal to that indicated in the wLength field 550 is included in the Data field 560.

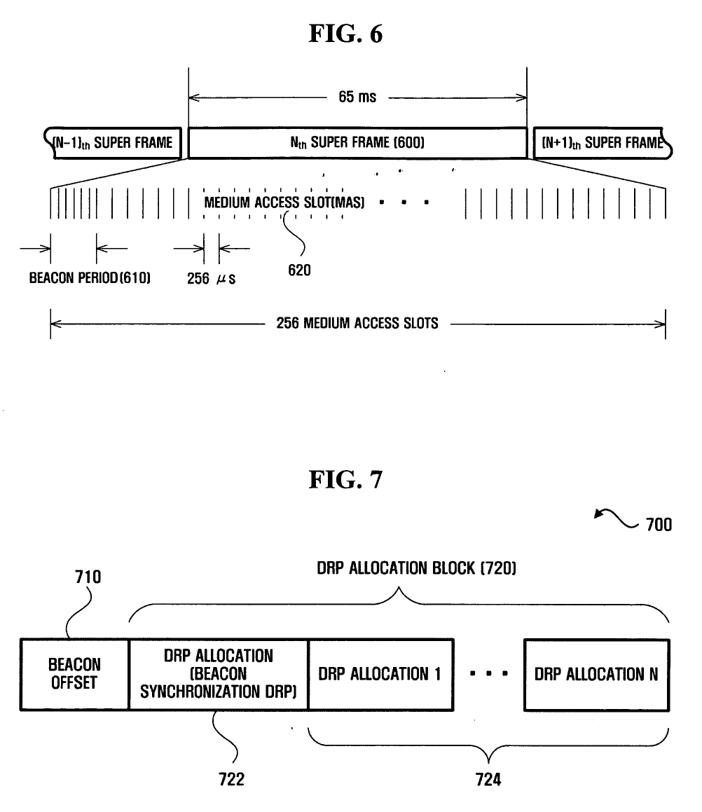

FIG. 6 is a diagram illustrating the arrangement of wireless USB channels according to an exemplary embodiment of the invention.

A channel is a transmission path between nodes, and a wireless physical layer configures wireless transmission in the frequency range by means of a technique for channels and compression. A data link layer arranged above the physical layer compresses or decompresses a bit stream of data packets transmitted or received to provide transport protocol information and management information, and processes frame synchronization, flow control, and error control in the physical layer. The data link layer includes logical link control and media access control (MAC) for managing information through the physical channel.

The wireless USB uses the physical layer and the MAC layer for defining an access to the access control layer channel and also uses the beacon for search and distribution control and the DRP for data communication according to the time division multiple access (TDMA) scheme.

As shown in FIG. 6, MAC layer channel time is composed of a super frame 600. The super frame 600 starts from a beacon period 610. The interval of the super frame 600 is 65 ms. The super frame 600 is logically classified into 256 media access slots 620, and the media access slot 620 positioned at a starting point of the super frame 600 is allocated for the beacon period 610.

The wireless USB defines a capsulized wireless USB channel to the super frame 600 through a media access slot reservation set (DRP) of the media access layer. The wireless USB channel is a continuous sequence of control packets, called micro-scheduled management commands (MMCs), and the MMC is transmitted by the host through the MAC layer reservation.

The MMC includes host identification information, an I/O control structure, and the time reference of the next MMC in the sequence (link). The capsulized channel provides the structure of a transmission path for data communication between the host and the device existing in the wireless USB cluster. The MMC is used by the host to maintain and control the wireless USB channel. The MMC is a management packet defined by an application, and is mainly composed of specific information elements.

In the wireless USB environment, generally, the wireless USB host transmits the beacon through the wireless USB channel and transmits the MMC in the DRP period, thereby performing the function of the point-to-point DRD host. However, in this exemplary embodiment, the wireless USB device 420 cannot create the beacon, and thus it cannot perform the function of the point-to-point DRD host. Therefore, the wireless USB host 410 transmits the DRP information to the wireless USB device 420 in the form of the control transfer packet 500 to allow the wireless USB device 420 to perform the function of the point-to-point DRD host. That is, the wireless USB host 410 creates and transmits the beacon and the control transfer packet 500 in the beacon period 610. Then, the wireless USB device 420 uses the DRP information received from the wireless USB host 410 to create the MMC and transmits the created MMC.

In order for this operation, information on the control transfer packet 500 created by the wireless USB host 410 and information on the synchronization of the MMC by the wireless USB device 420 may be included in the DRP information of the control transfer packet 500.

FIG. 7 is a diagram illustrating a payload 700 of the DRP information according to an exemplary embodiment of the invention. The payload 700 of the DRP information includes a beacon offset field 710 and a DRP allocation field block 720.

The beacon offset field 710 is a field used to notify time delayed from the transmission time of the beacon transmitted by the wireless USB host to the wireless USB device 420, and is used to calculate the DRP period and to synchronize the beacon. That is, the beacon offset field 710 is used for synchronization between the transmission of the beacon by the wireless USB host 410 and the transmission of the MMC by the wireless USB device 420.

In the DRP allocation field block 720, a DRP allocation field 722 subsequent to the beacon offset field 710 is a field for informing the start of the DRP allocation field, and is used to synchronize the beacon time.

The other DRP allocation fields 724 of the DRP allocation field block include channel time slot allocation information for creating the MMC and information on the transmission direction of data, and are used for the wireless USB device 420 to create and transmit the MMC.

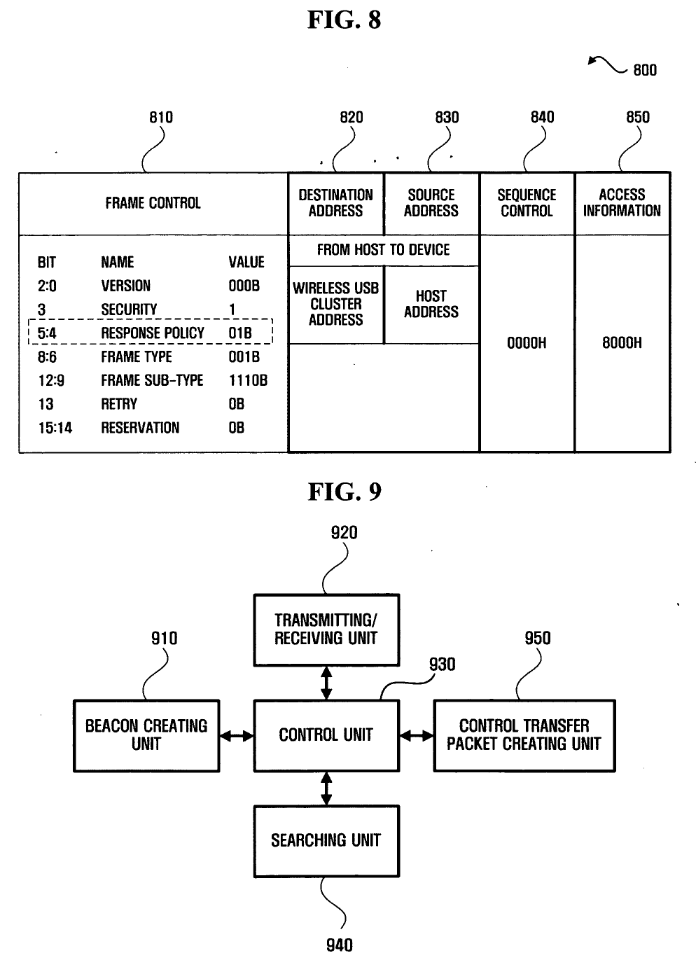

FIG. 8 is a diagram illustrating a header of the DRP information according to an exemplary embodiment of the invention. A header 800 of the DRP information includes a frame control field 810, a destination address field 820, a source address field 830, a sequence control field 840, and an access information field 850.

The frame control field 810 includes a version field, a security field, a response policy field, a frame type field, a frame sub-type field, a retry field, and a spare field. The structures of the fields other than the response policy field are the same as that of the header of the MMC packet. That is, a value requesting an immediate response is input to the response policy field to cause the wireless USB device 420 receiving the DRP information to make an immediate response.

Meanwhile, the frame type field is a field for indicating the type of frame. The frame type field shown in FIG. 8 indicates that the present frame is a control frame for the MMC packet.

The frame sub-type field is a field accompanied when the frame type field is the control field. The frame sub-type field shown in FIG. 8 indicates an application-specific control frame.

The address of the wireless USB cluster is input to the destination address field 820 of the header 800, and the address of the wireless USB host 410 transmitting the DRP information is input to the source address field 830. In this exemplary embodiment, in the point-to-point wireless USB environment, since the wireless USB device 420 is included in the wireless USB cluster, the wireless USB device 420 receives the DRP information and performs the function of the point-to-point DRD host.

The sequence control field 840 is not used in the wireless USB. Therefore, the wireless USB device 420 and the wireless USB host 410 input a value of “0000H” to the sequence control field 840.

The header 800 of the DRP information shown in FIG. 8 is combined with the payload 700 of the DRP information shown in FIG. 7 to form DRP information. When receiving the DRP information, the wireless USB device 420 performs the time synchronization of the beacon and creates and transmits the MMC.

FIG. 9 is a block diagram illustrating a wireless USB host according to an exemplary embodiment of the invention. The wireless USB host 410 includes a beacon creating unit 910, a searching unit 940, a transmitting/receiving unit 920, a control unit 930, and a control transfer packet creating unit 950.

In an exemplary embodiment of the invention, the wireless USB host 410 is an apparatus capable of creating and transmitting the beacon. It is assumed that, in the communication environment of the wireless USB point-to-point DRD, the wireless USB host 410 is supplied with power earlier than the wireless USB device 420, and is operated as the point-to-point DRD host.

When power is applied to the wireless USB host 410 and then another device (the wireless USB device 420) takes part in the network, the wireless USB host 410 sets up a default link to the wireless USB device 420. At that time, the wireless USB host 410 uses the management packet to notify the wireless USB device 420 that it can perform the function of the point-to-point DRD host.

Thereafter, the wireless USB device 420 searches the periphery thereof to find out the position of the wireless USB host 410. Then, connection between the wireless USB host 410 and the wireless USB device 420 is completed, so that a default link is set therebetween. The wireless USB host 410 searches out the wireless USB device 420. That is, the wireless USB host 410 grasps the performance of the wireless USB device 420. Then, the wireless USB device 420 transmits a message including information on the performance thereof to the wireless USB host 410.

The beacon creating unit 910 creates beacons. In an exemplary embodiment of the invention, the beacons are created by only the wireless USB host 410. Even when the wireless USB device 420 performs the function of the point-to-point DRD host, the beacons are transmitted in the beacon transmission period by only the wireless USB host 410.

The searching unit 940 searches whether the wireless USB device 420 can support a beacon behavior, with reference to the message received in the wireless USB point-to-point communication environment. The message includes the device capability descriptor transmitted by the wireless USB device 420. When the wireless USB device 420 supports the beacon behavior, a value of “1” is set to the point-to-point DRD capability field of the device capability descriptor, and a value of “01B” is set to the beacon behavior field. On the other hand, when the wireless USB device 420 does not support the function of a point-to-point DRD, a value of “11B” is set to the beacon behavior field. That is, the searching unit 940 searches whether the wireless USB device 420 can support the beacon behavior, on the basis of the value input to the point-to-point DRD capability field.

Meanwhile, the wireless USB device 420 is a point-to-point DRD, and in an exemplary embodiment of the invention, it is assumed that the wireless USB device 420 does not support the beacon behavior (the creation and transmission of the beacon).

The result searched by the searching unit 940 is transmitted to the control unit 930. When the result of the search shows that the wireless USB device 420 does not support the beacon behavior, the control unit 930 controls the control transfer packet creating unit 950 to create the control transfer packet 500.

Then, the control transfer packet creating unit 950 creates the control transfer packet 500 including beacon synchronization information, channel time allocation information, and information on the transmission direction of data.

The control transfer packet 500 may include a flag instructing the wireless USB device 420 to be operated as the point-to-point DRD host even when the wireless USB device 420 does not support the beacon behavior. In this case, the flag may be input to the wValue field 530 of the control transfer packet 500, as shown in FIG. 5.

The transmitting/receiving unit 920 transmits the beacon and the control transfer packet 500 on the basis of the beacon synchronization information, and transmits/receives data to/from the wireless USB device 420 on the basis of the channel time allocation information and the information on the transmission direction of data included in the management packet received from the wireless USB device 420.

As shown in FIG. 7, the beacon synchronization information includes the beacon offset field 710 and the DRP allocation field. The transmitting/receiving unit 920 transmits the beacon and the control transfer packet 500 in the beacon synchronization period 610, and transmits or receives data in the wireless USB cluster DRP period.

The control unit 930 controls the searching unit 940, the transmitting/receiving unit 920, the control transfer packet creating unit 950, and the wireless USB host 410.

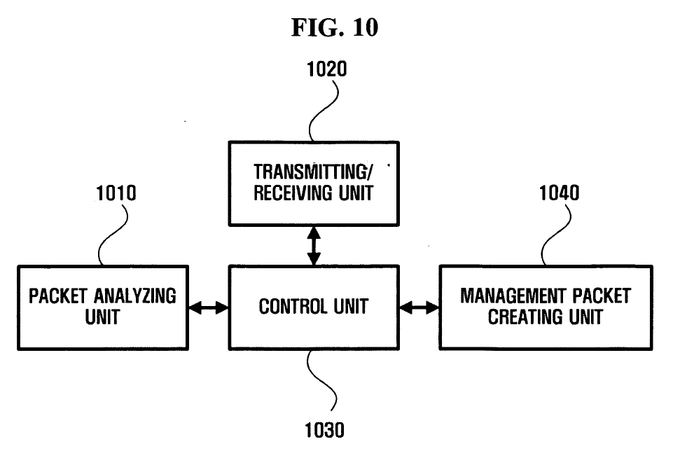

FIG. 10 is a block diagram illustrating a wireless USB device according to an exemplary embodiment of the invention. As shown in FIG. 10, the wireless USB device 420 includes a packet analyzing unit 1010, a transmitting/receiving unit 1020, a control unit 1030, and a management packet creating unit 1040.

In an exemplary embodiment of the invention, it is assumed that the wireless USB device 420 does not support the beacon behavior, is supplied with power later than the wireless USB host 410 in the communication environment of the wireless USB point-to-point DRD, and is operated as the point-to-point DRD.

When the wireless USB device 420 takes part in the network, the wireless USB device 420 sets up the default link to the wireless USB host 410. At that time, the wireless USB device 420 can recognize that the wireless USB host 410 can perform the function of a point-to-point DRD host, on the basis of the management packet received from the wireless USB host 410.

Thereafter, the wireless USB device 420 searches the periphery thereof to find out the position of the wireless USB host 410. Then, when connection between the wireless USB device 420 and the wireless USB host 410 is completed and the default link is set therebetween, the wireless USB host 410 searches out the wireless USB device 420. That is, the wireless USB host 410 searches whether the wireless USB device can perform the function of the point-to-point DRD host. Then, the wireless USB device 420 transmits a message including information on the performance thereof.

The packet analyzing unit 1010 analyzes the control transfer packet 500 received in the communication environment of the wireless USB point-to-point DRD. The control transfer packet 500 received by the wireless USB host 410 may include a flag instructing the wireless USB device 420 to be operated as the point-to-point DRD host. In this case, the flag can be input to the wValue field 530 of the control transfer packet 500, as shown in FIG. 5. That is, the packet analyzing unit 1010 searches whether the flag instructing the wireless USB device 420 to be operated as the point-to-point DRD host is included in the control transfer packet 500. When the flag is included in the control transfer packet 500, the packet analyzing unit 1010 transmits the DRP information included in the control transfer packet 500 to the control unit 1030.

When the DRP information is transmitted to the control unit 1030, the control unit 1030 causes the management packet creating unit 1040 to create the management packet. Then, the management packet creating unit 1040 creates the management packet including the channel time allocation information and the information on the transmission direction of data, on the basis of the result analyzed by the packet analyzing unit 1010, that is, the DRP information.

The management packet created by the management packet creating unit 1040 includes the MMC packet defined by the wireless USB standard.

The transmitting/receiving unit 1020 transmits the management packet, and transmits/receives data to/from the wireless USB host 410 on the basis of the channel time allocation information and the information on the transmission direction of data included in the management packet.

The wireless USB host 410 receives the transmitted management packet and performs the transmission/reception of data on the basis of the channel time allocation information and the information on the transmission direction of data included in the management packet. The transmitting/receiving unit 1020 receives the beacon and the control transfer packet 500 in the beacon synchronization period 610, and transmits or receives the management packet or data in the wireless USB cluster DRP period. That is, the transmitting/receiving unit 1020 communicates with the wireless USB host 410 through the default link.

The control unit 1030 controls the packet analyzing unit 1010, the transmitting/receiving unit 1020, the management packet creating unit 1040, and the wireless USB device 420.

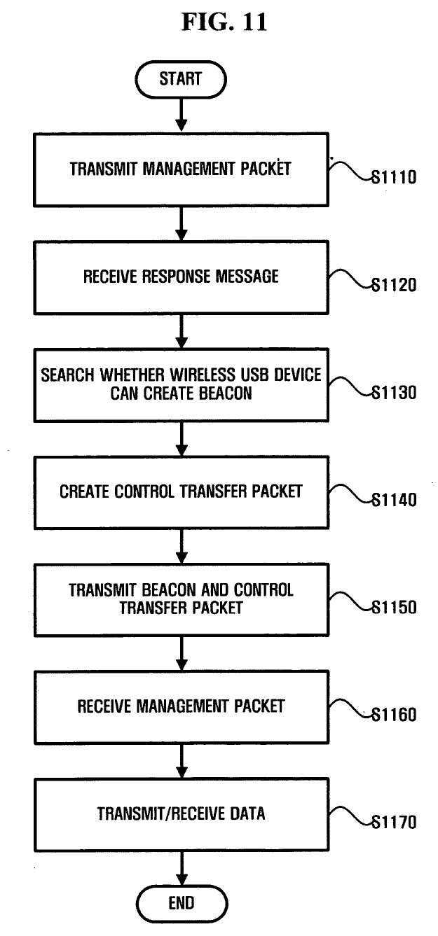

FIG. 11 is a flow chart illustrating a process of providing the function of the DRD host according to an exemplary embodiment of the invention. More specifically, FIG. 11 is a flow chart illustrating the operation of the wireless USB host 410 to allow the wireless USB device 420 to be operated as the point-to-point DRD host even when the wireless USB device 420 does not support the beacon behavior.

In order to provide the DRD host function to the wireless USB device 420, the wireless USB host 410 sets up the default link to the wireless USB device 420 and transmits, to the wireless USB device 420, the management packet including information indicating that it can perform the function of the point-to-point DRD host (S1110). The management packet includes the MMC packet defined by the wireless USB standard.

The wireless USB host 410 receives a response message, which is a response to the management packet, from the wireless USB device 420 (S1120), and the response message includes information indicating whether the wireless USB device 420 can perform the function of the point-to-point DRD host, that is, the wireless USB device 420 can support the beacon behavior.

The searching unit 940 of the wireless USB host 410 searches whether the wireless USB device 420 can create the beacon, on the basis of the received message (S1130). The message includes the device capability descriptor transmitted by the wireless USB device 420. Then, the searching unit 940 checks the beacon behavior field and the point-to-point DRD capability field included in the device capability descriptor to search whether the wireless USB device can perform the beacon behavior.

Subsequently, the result searched by the searching unit 940 is transmitted to the control unit 930. After confirming the searched result, the control unit 930 controls the control transfer packet creating unit 950 to create the corresponding control transfer packet 500.

Then, the control transfer packet creating unit 950 of the wireless USB host 410 creates the control transfer packet 500 including the beacon synchronization information, the channel time allocation information, and the information on the transmission direction of data (S1140). The control transfer packet 500 may include a flag instructing the wireless USB device 420 to be operated as the point-to-point DRD host when the wireless USB device 420 does not support the beacon behavior. In this case, the flag may be input to the wValue field 530 of the control transfer packet 500.

After the control transfer packet 500 is created, the transmitting/receiving unit 920 of the wireless USB host 410 transmits the beacon and the control transfer packet 500 (S1150). Then, the wireless USB device 420 transmits the management packet including the channel time allocation information and information on the transmission direction of data. The transmitting/receiving unit 920 of the wireless USB host 410 receives the management packet transmitted from the wireless USB device 420 (S1160), and performs data communication with the wireless USB device 420 on the basis of the management packet (S1170).

In this case, the beacon and the control transfer packet 500 may be transmitted in the beacon synchronization period 610, and the management packet and data of the wireless USB device 420 may be transmitted or received in the wireless USB cluster DRP period.

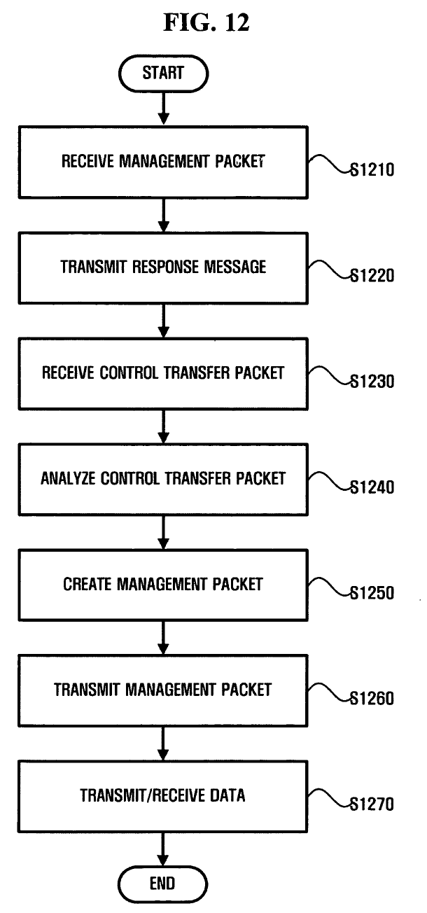

FIG. 12 is a flow chart illustrating a process of performing the function of the DRD host according to an exemplary embodiment of the invention. More specifically, FIG. 12 is a flow chart illustrating the operation of the wireless USB device 420 creating a management packet using information received from the wireless USB host 410 and transmitting the management packet, thereby performing the function of a DRD.

In order to perform the function of a DRD host, the wireless USB device 420 sets a default link to the wireless USB host 410 and then receives from the wireless USB host 410 the management packet including information indicating that the function of the point-to-point DRD host is available (S1210).

After receiving the management packet, the wireless USB device 420 transmits a response message (S1220). The response message includes information on whether the wireless USB device 420 can support the function of the point-to-point DRD host.

Also, the response message includes a device capability descriptor. However, in the invention, since the wireless USB device 420 does not support the function of the point-to-point DRD host, a device capability descriptor having a point-to-point DRD capability field of “1” and a beacon behavior field of “11B” is transmitted to the wireless USB host 410.

Then, the transmitting/receiving unit 1020 of the wireless USB device 420 receives the control transfer packet 500 from the wireless USB host 410 (S1230). The control transfer packet 500 includes, for example, the beacon synchronization information, the channel time allocation information, and the information on the transmission direction of data.

Subsequently, the packet analyzing unit 1010 of the wireless USB device 420 analyzes the received control transfer packet 500 (S1240). In this case, the control transfer packet 500 may include a flag instructing the wireless USB device 420 to be operated as the point-to-point DRD host, and the flag may be input to the wValue field 530 of the control transfer packet 500.

When the packet analyzing unit 1010 completely analyzes the control transfer packet 500, the management packet creating unit 1040 creates a management packet on the basis of the analyzed result (S1250). That is, the management packet creating unit 1040 creates a management packet including channel time allocation information and information on the transmission direction of data on the basis of the DRP information included in the control transfer packet 500. The management packet includes an MMC packet defined by the wireless universal serial bus standard.

After the management packet is created, the transmitting/receiving unit 1020 of the wireless USB device 420 transmits the management packet (S1260) and performs data communication with the wireless USB host 410 on the basis of the channel time allocation information and the information on the transmission direction of data included in the management packet (S1270).

In this case, the transmitting/receiving unit 1020 of the wireless USB device 420 can receive the control transfer packet 500 in the beacon synchronization period 610 and can transmit the management packet and data in the wireless USB cluster DRP period.

While the exemplary embodiments of the invention have been described above with reference to the accompanying drawings, it will be understood by those skilled in the art that various modifications and changes of the invention can be made without departing from the scope and spirit of the invention. Therefore, it should be understood that the above-described embodiment is not restrictive, but illustrative in all aspects.

As described above, according to the wireless USB host, the wireless USB device, the method of providing the function of a DRD host, and the method of performing the function of the DRD host of the invention, the following effects can be obtained.

First, it is possible to realize a point-to-point network using only a default link without an opposite link in the wireless USB environment, and thus to reduce the number of wireless channels used.

Second, it is possible to make an apparatus unable to provide a beacon perform the function of a DRD host.

What is claimed is:

1. A wireless universal serial bus (USB) host comprising:
a searching unit which searches whether a wireless USB device can create a beacon on the basis of a message received in a wireless USB point-to-point dual role device communication environment;
a control transfer packet creating unit which creates a control transfer packet comprising beacon synchronization information, channel time allocation information, and information on a transmission direction of data on the basis of the searched result; and
a transmitting/receiving unit which transmits the control transfer packet on the basis of the beacon synchronization information and performs data communication with the wireless USB device on the basis of the channel time allocation information and the information on the transmission direction of data.

2. The wireless USB host of claim 1, wherein the message comprises a device capability descriptor transmitted by the wireless USB device.

3. The wireless USB host of claim 2, wherein the message is received in response to a management packet generated by the wireless USB host, and
wherein the management packet comprises information indicating that the wireless USB device can perform a function of a wireless USB point-to-point dual role device host.

4. The wireless USB host of claim 1, wherein, if the wireless USB device does not support the beacon, the control transfer packet comprises a flag instructing the wireless USB device to be operated as a point-to-point dual role device host.

5. The wireless USB host of claim 1, wherein the control transfer packet is transmitted in a beacon synchronization period in the wireless USB point-to-point dual role device communication environment.

6. The wireless USB host of claim 1, wherein the transmitting/receiving unit transmits the control transfer packet to the wireless USB device and performs data communication with the wireless USB device through a default link.

7. A wireless universal serial bus (USB) device comprising:
a packet analyzing unit which analyzes a control transfer packet received in a wireless USB point-to-point dual role device communication environment;
a management packet creating unit which creates a management packet comprising channel time allocation information and information on a transmission direction of data on the basis of the analyzed result; and
a transmitting/receiving unit which transmits the management packet and performs data communication with a wireless USB host on the basis of the channel time allocation information and the information on the transmission direction of data.

8. The wireless USB device of claim 7, wherein the control transfer packet comprises a flag instructing the wireless USB device to be operated as a point-to-point dual role device host.

9. The wireless USB device of claim 7, wherein the control transfer packet is received in a beacon synchronization period in the wireless USB point-to-point dual role device communication environment.

10. The wireless USB device of claim 7,
wherein the management packet comprises a micro-scheduled management command packet defined by a wireless USB standard.

11. The wireless USB device of claim 7, wherein the transmitting/receiving unit transmits a device capability descriptor comprising information indicating whether the beacon can be created by the wireless USB device.

12. The wireless USB device of claim 11, wherein the device capability descriptor is transmitted in response to another management packet generated by the wireless USB host, and
wherein the other management packet comprises information indicating that the wireless USB device can perform a function of a wireless USB point-to-point dual role device host.

13. The wireless USB device of claim 7, wherein the transmitting/receiving unit transmits the management packet to the wireless USB host and performs data communication with the wireless USB host through a default link.

14. A method of providing a function of a dual role device host, comprising:
searching whether a wireless USB device can create a beacon on the basis of a message received in a wireless USB point-to-point dual role device communication environment;
creating a control transfer packet comprising beacon synchronization information, channel time allocation information, and information on a transmission direction of data on the basis of the searched result; and
transmitting the control transfer packet on the basis of the beacon synchronization information and performing data communication with the wireless USB device on the basis of the channel time allocation information and the information on the transmission direction of data.

15. The method of claim 14, wherein the message comprises a device capability descriptor transmitted by the wireless USB device.

16. The method of claim 15, wherein the message is received in response to a management packet comprising information indicating that the wireless USB device can perform a function of a wireless USB point-to-point dual role device host.

17. The method of claim 14, wherein, if the wireless USB device does not support the beacon, the control transfer packet comprises a flag instructing the wireless USB device to be operated as a point-to-point dual role device host.

18. The method of claim 14, wherein the control transfer packet is transmitted in a beacon synchronization period in the wireless USB point-to-point dual role device communication environment.

19. The method of claim 14, wherein, in the transmission of the control transfer packet and the data, the control transfer packet is transmitted to the wireless USB device and data communication with the wireless USB device is performed through a default link.

20. A method of performing a function of a dual role device, comprising:
analyzing a control transfer packet received in a wireless USB point-to-point dual role device communication environment;
creating a management packet comprising channel time allocation information and information on a transmission direction of data on the basis of the analyzed result; and
transmitting the management packet and performing data communication with a wireless USB host on the basis of the channel time allocation information and the information on the transmission direction of data.

21. The method of claim 20, wherein the control transfer packet comprises a flag instructing a wireless USB device to be operated as a point-to-point dual role device host.

22. The method of claim 20, wherein the control transfer packet is received in a beacon synchronization period in the wireless USB point-to-point dual role device communication environment.

23. The method of claim 20, wherein the management packet comprises a micro-scheduled management command packet defined by a wireless USB standard.

24. The method of claim 20, further comprising transmitting a device capability descriptor comprising information indicating whether the beacon can be created by a wireless USB device.

25. The method of claim 24, wherein the device capability descriptor is transmitted in response to another management packet comprising information indicating that the wireless USB device can perform a function of a wireless USB point-to-point dual role device host.

26. The method of claim 20, wherein, in the transmission of the management packet and the data, the management packet is transmitted to the wireless USB host and data communication with the wireless USB host is performed through a default link.
